(19) United States
(12) Patent Application Publication
(10) Pub. No.: US 2008/0100463 A1
(43) Pub. Date: May 1, 2008

(54) Alarm shut off system

(76) Inventor: Harold Shirlee, Little Rock, AR (US)

Correspondence Address: Harold Shirlee, 5406 Dreher Lane, Little Rock, AR, 72209, US

(21) Appl. No.: 12/003,502

(22) Filed: Dec. 26, 2007

Related U.S. Application Data
(63) Continuation of application No. 11/037,946, filed on Mar. 31, 2005, now Pat. No. 7,199,721.

(51) Int. Cl. G08B 17/10

(52) U.S. Cl. 340/628

(57) ABSTRACT

The Gas and Electric Alarm Shut Off System is an invention that will prevent smoke from growing into a fire. This will save lives and property.

### BACKGROUND OF THE INVENTION

The invention relates to a smoke alarm system that will not only detect when there is smoke, but will shut off the supply of gas or electric from the appliance to prevent the smoke from growing into a fire.

There are many types of smoke alarm systems already in use. However, many of these will only detect when there is smoke or fire. There are some that will respond to the smoke or fire by a water sprinkle system. With the water sprinkle system sometimes that which is not damaged by the smoke and fire is damaged by the water sprinkle system.

Unfortunately, there isn't a smoke or fire alarm system that will actually prevent the smoke from growing into a fire without causing additional damage (like water damage). Thus there is a need for a system that will not only detect smoke, but will go a step further and prevent the smoke from growing into a fire without causing further damage. This is what this Alarm Shut Off System does. This invention will detect the smoke and then shut the supply of gas or electric power off from the appliance. This will prevent the smoke from growing into a fire without causing further damage, saving lives and property.

### SUMMARY OF THE INVENTION

The object of this invention is to provide a smoke or fire alarm system that will prevent a smoke from growing into a fire without adding further damage. To accomplish this objective an “Alarm Shut Off System” will be installed between the supply line (gas or electric) and the appliance. A smoke detector that comes with the system has a TRANSMITTER wired inside of the smoke detector. When the smoke detector is activated to send out the alarm warning signal the TRANSMITTER is activated to send out a signal to a RECEIVER on the Alarm Shut Off System.

The RECEIVER will receive a signal from the alarm TRANSMITTER. When the RECEIVER receives a signal from the alarm TRANSMITTER the RECEIVER will activate a user controller POTENTIOMETER. The user may set the POTENTIOMETER to the amount of time the user wants to expire before the Alarm Shut Off System shuts off the supply of gas or electric from the appliance. If the user brings the situation under control before the selected time expires the user should push the RESET BUTTON. This will stop the POTENTIOMETER'S count down and prevent the Alarm Shut Off System from shutting the supply of gas or electric from the appliance, as well as resetting the Alarm Shut Off System for duty.

However, if the user is not around or fails to bring the situation under control before the selected amount of time on the POTENTIOMETER has expired the Alarm Shut Off System will automatically shut off the supply of gas or electric from the appliance in order to prevent the situation from growing into a fire. This in effect will save lives and property.

### DETAIL DESCRIPTION AND OPERATION OF THE SMOKE ALARM SHUT OFF SYSTEM: GAS AND ELECTRIC

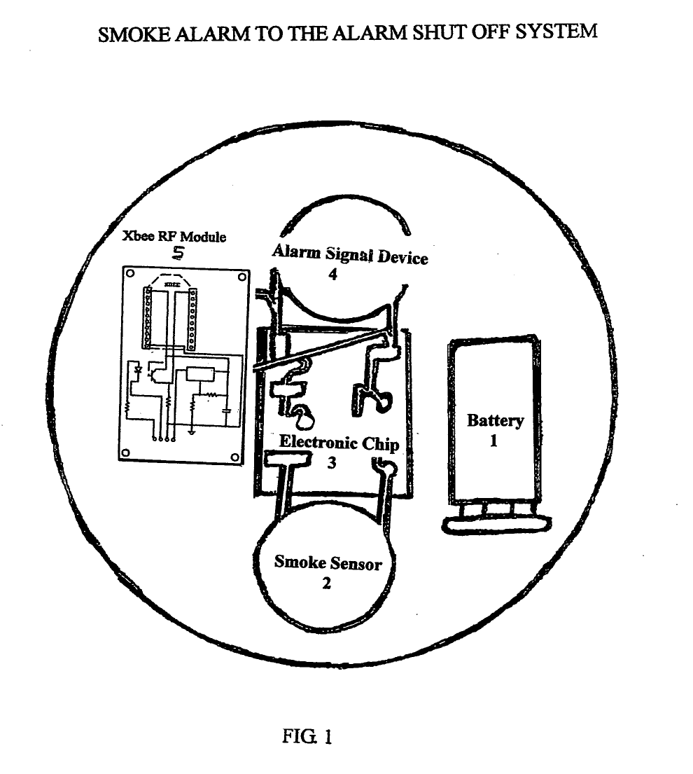

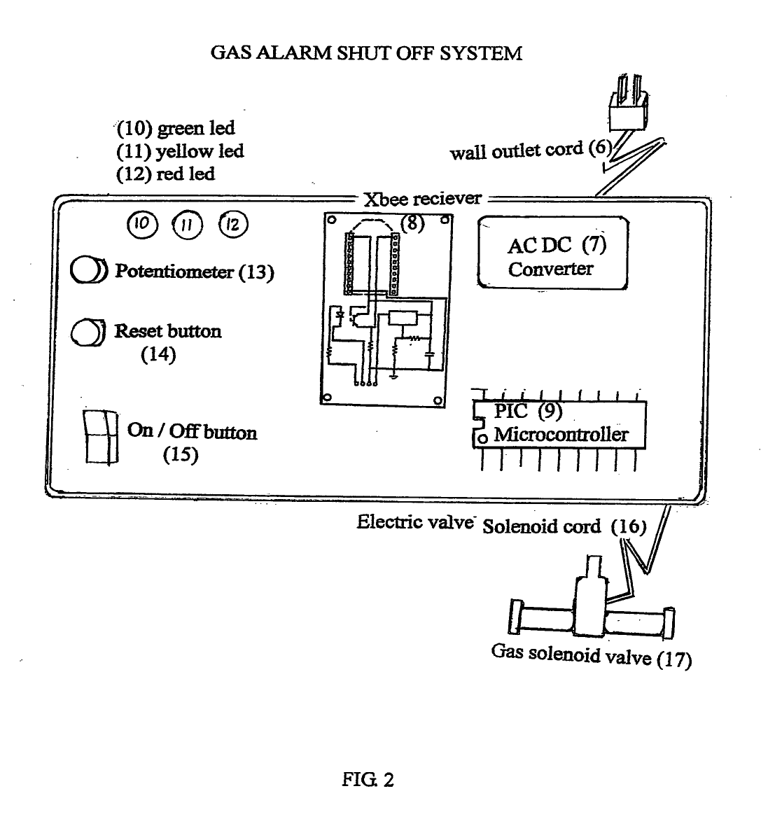

Starting with the SMOKE DETECTOR ALARM (FIG. 1) that comes as a part of the Alarm Shut Off System. It is operated by battery (1). First a smoke sensor (2) will detect smoke. It will send that detection through an electronic chip (3) to an alarm signal device (4) that makes the smoke alarm sound. A Xbee RF module board (5) is wired directly into an alarm signal device. Therefore the same signal that the electronic chip (3) sends to the alarm signal device (4) is also sent to the Xbee RF module board (5). The Xbee RF module board (5) transmits a signal to the Shut Off System (FIG. 2) at the same time that the smoke alarm is sounding.

### DETAIL DESCRIPTION AND OPERATION OF THE GAS SMOKE DETECTOR ALARM

The Smoke Detector (FIG. 1) comes as a part of the Alarm Shut Off System. It is operated by battery (1). First a smoke sensor (2) will detect smoke. It will send that detection through an electronic chip (3) to an alarm signal device (4) that makes the smoke alarm sound. A Xbee RF module board (5) is wired directly into an alarm signal device (4). Therefore the same signal that the electronic chip (3) sends to the alarm signal device (4) is also sent to the Xbee RF module board (5). The Xbee RF module board (5) transmits a signal to the Shut Off System (FIG. 2) at the same time that the smoke alarm is sounding.

### DETAILED DESCRIPTION AND OPERATION OF THE GAS ALARM SHUT OFF SYSTEM (FIG. 2)

The Gas Shut Off System is powered from a 110 V AC (6), using a 5V AC-DC converter (7). The Gas Shut Off System receives the transmitted signal from a smoke detector (FIG. 1) via another Xbee module board (8) configured as a receiver. A PIC microcontroller (9) controls the functionality of the Shut Off System. When the Shut Off System is armed (turned on) a PIC microcontroller causes a green LED (10) to light. Upon receiving a signal from a Xbee module board receiver (8) a PIC microcontroller (9) will cause a yellow LED (11) to light. PIC lights are set by a user controller potentiometer (13). If at the end of the delay time and the user has not turned off the Alarm Shut Off System with the off button (15), or pressed a reset button (14), a PIC Microcontroller (9) will send a signal through an electrical cord (16) to a gas solenoid valve (17) to shut off the gas from the incoming gas supply line (18). Once the gas supply line (18) is shut off the PIC microcontroller (9) will cause a red LED (12) to light showing that the Gas Shut Off System has shut off the gas supply from the appliance. The smoke will not grow into a fire. Thus, lives and property have been saved.

RESET: The user may restore the supply of gas to an appliance by pressing a reset button (14). A green LED (10) will come on. The green LED (10) means that the Gas Shut Off System is reset and armed again.

### DETAIL DESCRIPTION AND OPERATION OF THE ELECTRIC SMOKE DETECTOR ALARM

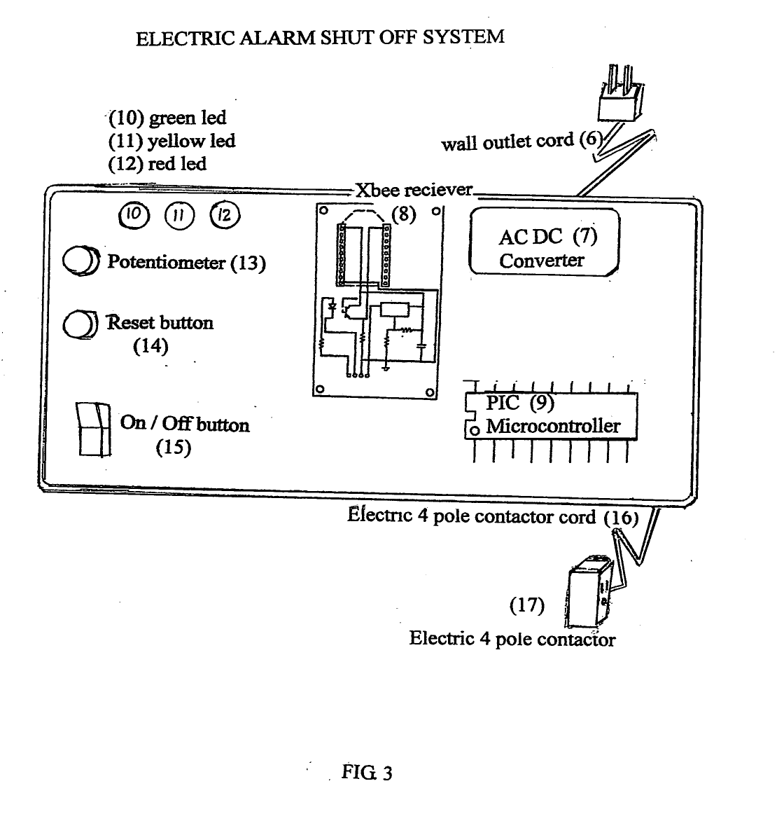

Repeating the detailed description and operation of the Smoke Detector Alarm (FIG. 1) that operates the Gas Alarm Shut Off System (FIG. 2). It performs the same operation on the Electric Alarm Shut Off System (FIG. 3). It is operated by battery (1). First a smoke sensor (2) will detect smoke. It will send that detection through an electronic chip (3) to an alarm signal device (4) that makes the smoke alarm sound. A Xbee RF module board (5) is wired directly into an alarm signal device (4). Therefore the same signal that the electronic chip (3) sends to the alarm signal device (4) is also sent to the Xbee RF module board (5). The Xbee RF module board (5) transmits a signal to the Electric Shut Off System (FIG. 3) at the same time that the smoke alarm is sounding.

### DETAIL DESCRIPTION AND OPERATION OF THE ELECTRIC ALARM SHUT OFF SYSTEM (FIG. 3)

The Electric Shut Off System is powered from a 110 V AC (6), using a 5V AC DC converter (7). The Electric Shut Off System receives the transmitted signal from a smoke detector (FIG. 1) via another Xbee module board (8) configured as a receiver. A PIC microcontroller (9) controls the functionality of the Electric Shut Off System. When the Electric Shut Off System is armed (turned on) the PIC microcontroller (9) causes a green LED (10) to light. Upon receiving a signal from a Xbee module board receiver (8) a PIC microcontroller (9) will cause a yellow LED (11) to light. PIC lights are set by a user controller potentiometer (13). If at the end of the delay time the user has not turned off the Electric Alarm Shut Off System with an off button (15), or pressed a reset button (14), the PIC microcontroller (9) will send a signal through an electrical Cord (16) to an electric 4 pole contactor (17). The electric 4 pole contractor (17) will disconnect the incoming flow of electric from the electric appliance. This will prevent the smoke from growing into a fire. Thus, lives and property have been saved.

RESET: The user may restore the supply of electric to an appliance by pressing a reset button (14). A green LED will come on. The green LED means that the Electric Shut System is reset and armed again.

1. An Electric Alarm Shut Off System comprising:
A smoke detector having a battery, a smoke sensor, an electronic chip, an alarm signal device, a Xbee RF module.
An electric shut off system having an electric wall plug in cord, an AC DC converter, a Xbee receiver, a PIC microcontroller, a green led, a yellow led, a red led, a potentiometer, a reset button, an on and off switch, an electric 4 pole contactor cord, an electric 4 pole contactor.
